(19) United States
(12) Patent Application Publication
(10) Pub. No.: US 2021/0121908 A1
(43) Pub. Date: Apr. 29, 2021

(54) Disposable Piezoelectric Discharge Cartridge

(71) Applicants: Rami Sidawi, Milton (CA); Asad Rahman, Keswick (CA); Todd Muderlak, Whitefish Bay, WI (US)

(72) Inventors: Rami Sidawi, Milton (CA); Asad Rahman, Keswick (CA); Todd Muderlak, Whitefish Bay, WI (US)

(21) Appl. No.: 16/666,362

(22) Filed: Oct. 28, 2019

(51) Int. Cl. B05B 17/00; B05B 12/14

(52) U.S. Cl. CPC B05B 17/0646; B05B 17/0676; B05B 12/1409

(57) ABSTRACT

A piezoelectric liquid cartridge for a dispenser unit a cartridge body, a piezoelectric discharge nozzle supported by the body and including a micro-perforated vibratory plate a liquid reservoir supported by the body, and a wick. A liquid path from the liquid reservoir to the piezoelectric nozzle includes a channel. The wick is at least partially positioned in the channel. The wick includes a first fibrous wick portion in engagement with the vibratory plate of the piezoelectric discharge nozzle and a second non-fibrous wick portion. The piezoelectric cartridge is installable in the housing of the dispenser unit with electrical contacts of the cartridge connectable to corresponding electrical contacts of the dispenser to enable the micro-perforated vibratory plate to release atomized liquid particles from the piezoelectric discharge nozzle.

### FIELD

This invention relates, generally, to liquid discharge cartridges and, more particularly, to disposable piezoelectric discharge cartridges.

### BACKGROUND

Liquid dispensers of various types constitute a large market and have become popular in commercial and residential applications. For example, liquid dispensers for air freshener products with a metered aerosol fragrance dispensers have become popular in commercial settings such as public and office restrooms. Devices are typically complex, many with an electric motor, a gear drive operated by the motor which actuates the spray valve, an aerosol fragrance canister, and a programmable timer for adjusting the time interval between sprays. Cost for various dispensers also tends to be high, and failure is frequent due to, for example, the complexity and mechanics of the dispensers. Another problem with dispensers is the tendency to leak, for example, during shipping and transportation of the product prior to first use. The dispensers also may leak and flood during operation.

### SUMMARY

In embodiments, disclosed is a piezoelectric liquid cartridge for a dispenser unit that has a housing with a power source, a control unit, and electrical contacts, that comprises a cartridge body, a piezoelectric discharge nozzle supported by the body and including a micro-perforated vibratory plate, a liquid reservoir supported by the body, a wick, and a liquid path from the liquid reservoir to the piezoelectric nozzle. In embodiments, the liquid path includes a channel, the wick is at least partially positioned in the channel, and the wick includes a first fibrous wick portion in engagement with the vibratory plate of the piezoelectric discharge nozzle and a second non-fibrous wick portion. In embodiments, the cartridge includes electrical contacts connected to the micro-perforated vibratory plate, and the piezoelectric cartridge is installable in the housing of the dispenser unit with the electrical contacts of the cartridge connected to corresponding electrical contacts of the dispenser to enable the micro-perforated vibratory plate to release atomized liquid particles from the piezoelectric discharge nozzle.

In embodiments, a piezoelectric liquid cartridge for a dispenser unit comprises a cartridge body, a piezoelectric discharge nozzle supported by the body and a micro-perforated vibratory plate, a liquid reservoir supported by the body, and a wick at least partially defining a liquid flow path from the liquid reservoir to the piezoelectric nozzle. In embodiments, the wick includes a first fibrous wick portion in engagement with the vibratory plate of the piezoelectric discharge nozzle and a second non-fibrous wick portion.

In embodiments, a piezoelectric liquid cartridge for a dispenser unit that has a housing with a power source, a control unit, and electrical contacts, comprises a cartridge body, a piezoelectric discharge nozzle supported by the body and including a micro-perforated vibratory plate with micro-perforations having a first size and a second size, a liquid reservoir supported by the body, and a wick. In embodiments, the cartridge includes a liquid path from the liquid reservoir to the piezoelectric nozzle, and the liquid path includes a channel. In embodiments, the wick is at least partially positioned in the channel, and the wick includes a first fibrous wick portion in engagement with the vibratory plate of the piezoelectric discharge nozzle. In embodiments, the cartridge includes electrical contacts connected to the micro-perforated vibratory plate, and the piezoelectric cartridge is installable in the housing of the dispenser unit with the electrical contacts of the cartridge connected to corresponding electrical contacts of the dispenser to enable the micro-perforated vibratory plate to release atomized liquid particles from the piezoelectric discharge nozzle.

### BRIEF DESCRIPTION OF THE DRAWINGS

Certain embodiments will be described with reference to the accompanying drawings, in which:

FIG. 1 is a perspective view of an embodiment of a piezoelectric discharge cartridge.

FIG. 2 is a perspective view of the cartridge of FIG. 1 with a retainer removed.

FIG. 3 is a perspective view of the cartridge of FIG. 1 with the reservoir in another position.

FIG. 4 is an exploded view of the cartridge of FIG. 1

FIG. 5 is a side cross-sectional view of the cartridge of FIG. 1.

FIG. 6A is a front cross-sectional view of the cartridge of FIG. 1.

FIG. 6B is a front cross-sectional view of the cartridge of FIG. 1 with the reservoir in another position.

FIG. 7 is a side cross-sectional view of the cartridge of FIG. 1 with the reservoir in another position.

FIG. 8 is a top view of the dispenser of FIG. 1 with the reservoir removed.

FIG. 9 is an exploded view of components of a piezoelectric nozzle of the cartridge of FIG. 1.

FIG. 10 is a rear view of a piezoelectric element of the cartridge of FIG. 1.

FIG. 11 is a rear view of a wick of the cartridge of FIG. 1.

FIG. 12 is a front view of a cartridge of FIG. 1 in a dispenser with a cover.

FIG. 13 is a side view of the cartridge and dispenser of FIG. 1 with the cover removed.

FIG. 14 is a side cross-sectional view of the cartridge and dispenser of FIG. 1.

FIG. 15 is a rear view of the cartridge of FIG. 1.

FIG. 16 is an embodiment of micro-perforations of a piezoelectric plate of a piezoelectric discharge cartridge.

FIG. 17 is an embodiment of micro-perforations of a piezoelectric plate of a piezoelectric discharge cartridge.

FIG. 18 is an embodiment of micro-perforations of a piezoelectric plate of a piezoelectric discharge cartridge.

### DESCRIPTION

Various embodiments will now be described in detail with reference to the attached drawing. It is to be understood that the drawings are not necessarily drawn to scale and that they are intended to be merely illustrative.

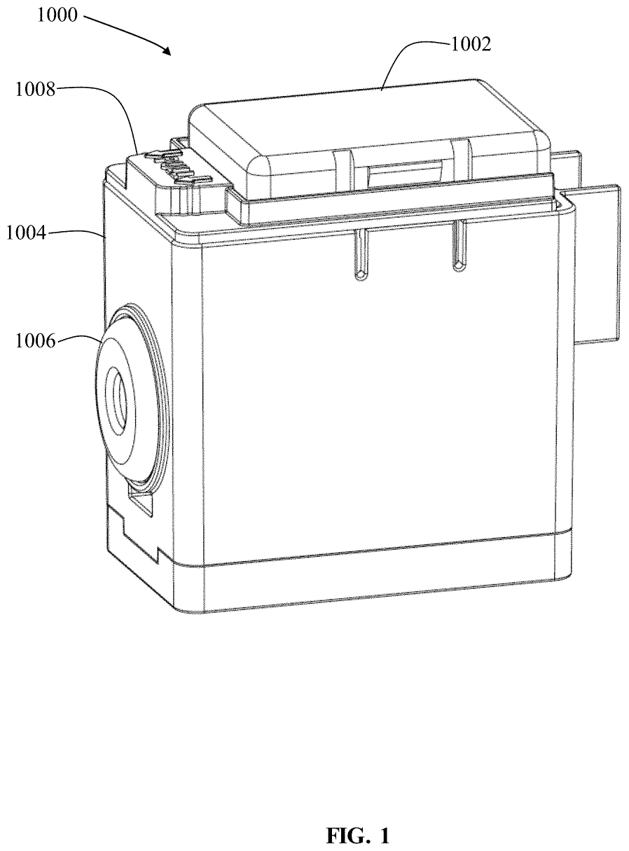

FIG. 1 depicts an embodiment of a disposable liquid cartridge that is installable within a dispenser unit. In the embodiment shown, a liquid cartridge 1000 includes a housing or cartridge body 1004 with a bottle or reservoir 1002 that stores a liquid to be dispensed by the cartridge through a piezoelectric discharge nozzle 1006. Cartridge 1000 further includes a retainer 1008 in this embodiment. The cartridge may include features that prevent undesirable fluid flow and leaking from the cartridge when the cartridge is not in use, such as during shipping and transportation. For example, the cartridge in embodiments may include features to selectively cause the reservoir to change from a state in which fluid is prevented from flowing from the reservoir, such as a state in which the reservoir is closed, to a state in which fluid may flow from the reservoir, such as a state in which the reservoir is opened, so that fluid may be selectively discharged from the piezoelectric discharge nozzle.

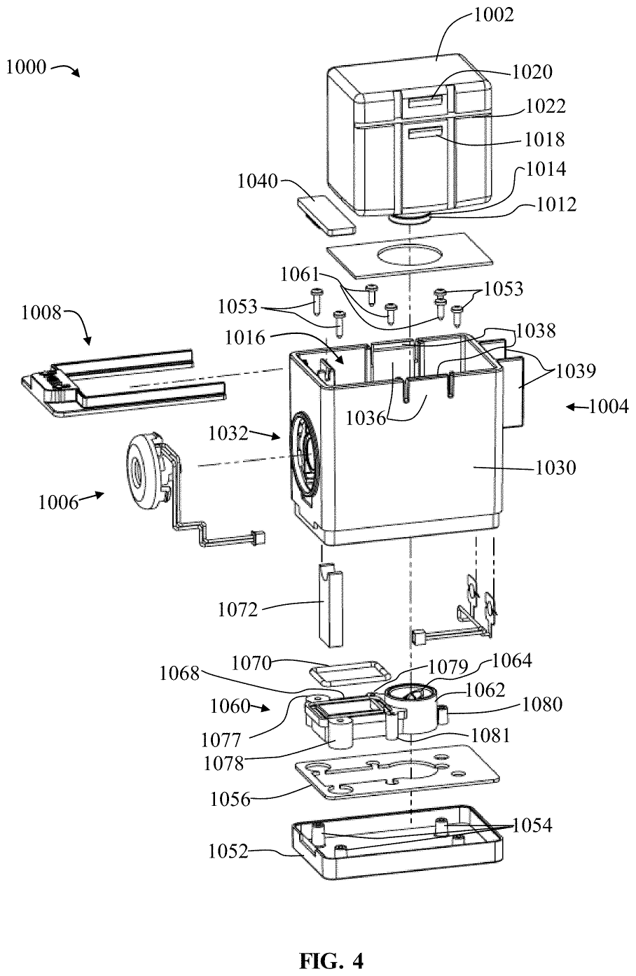

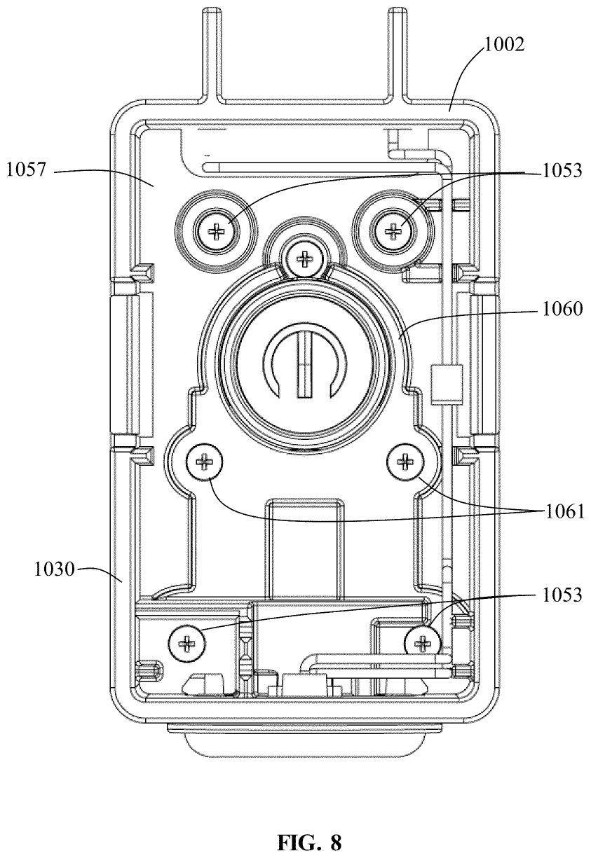

With reference to FIG. 4, cartridge body 1004 includes a housing body 1030 with an opening 1032 in which piezoelectric discharge nozzle 1006 is seated, and an interior space 1016 into which reservoir 1002 is insertable. The bottom of housing body 1030 is covered by a housing base cap 1052. Base cap 1052 in the embodiment shown is secured to the cartridge body by screws 1053 that extend through bosses 1054 and fastener openings in a bottom plate 1057 (FIG. 8) of the housing body 1030. As will be recognized, in other embodiments, other suitable ways of securing components together may be utilized, such as adhesive, welding, snap-fit, or for example, such components may be formed together as a single piece. As an example, housing body 1030 in embodiments is one-piece with one or more other components, such as base cap 1052. Cartridge body 1004 further includes a first and second fin or protrusion 1039 that may fit in a corresponding opening in a sensor of a dispenser unit that senses whether a fin or protrusion 1039 is present, which indicates whether a cartridge is installed.

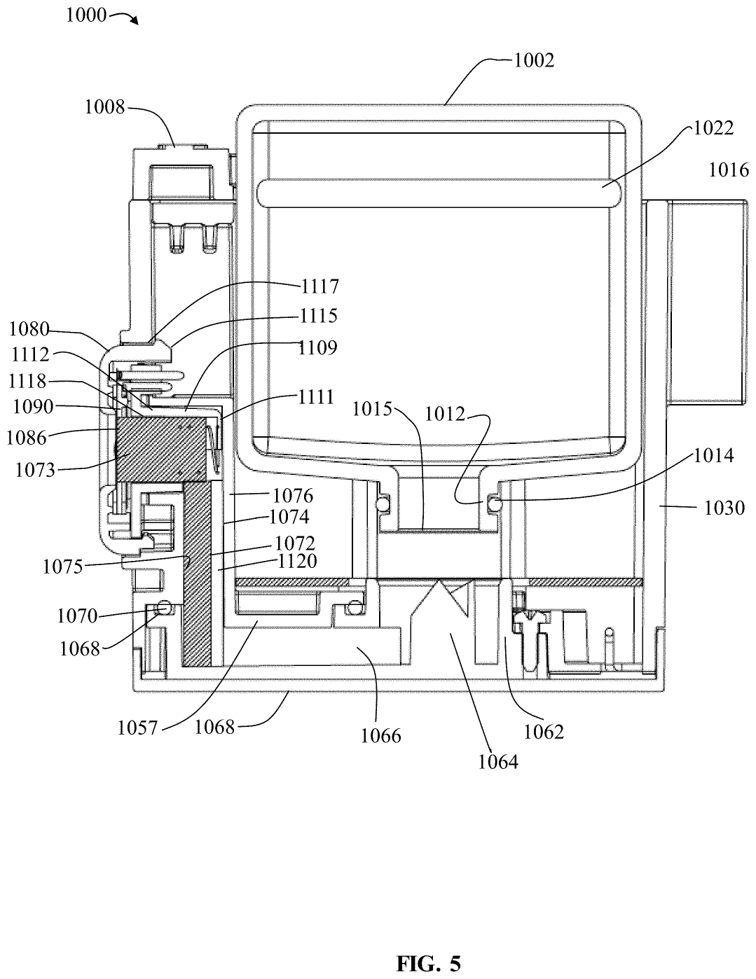

With continued reference to FIG. 4, reservoir 1002 may include a neck 1012 at its base with a seal or O-ring 1014. A reservoir cover 1015 (FIG. 5) may extend over the opening of the neck 1012 and prevents liquid from escaping prior to operating cartridge 1000. In the embodiment shown, the opening through neck 1012 may be induction sealed by a foil and polymeric membrane cover 1015 that prevents fluid flow from the reservoir. A membrane cover 1015 of such an embodiment may be pierced to enable fluid flow from the reservoir when liquid dispensation is desirable, for example, after the shipping or transportation to an end user. Other various covers may be utilized, such as snap-on covers, threaded covers, twist covers, plugs, seals, or other covers embodied with the reservoir, or separately from the reservoir, and including covers that may be selectively opened.

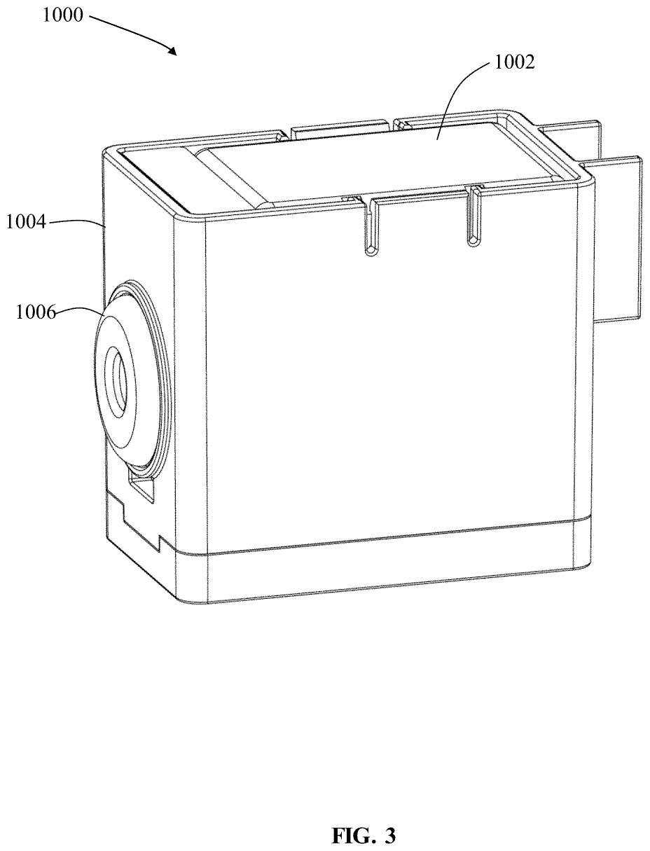

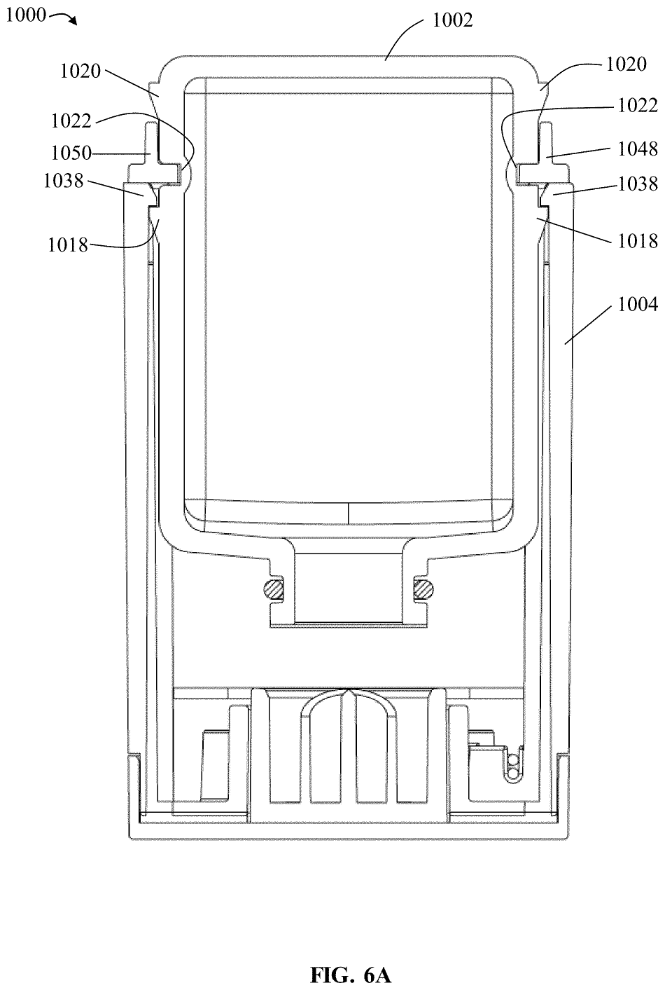

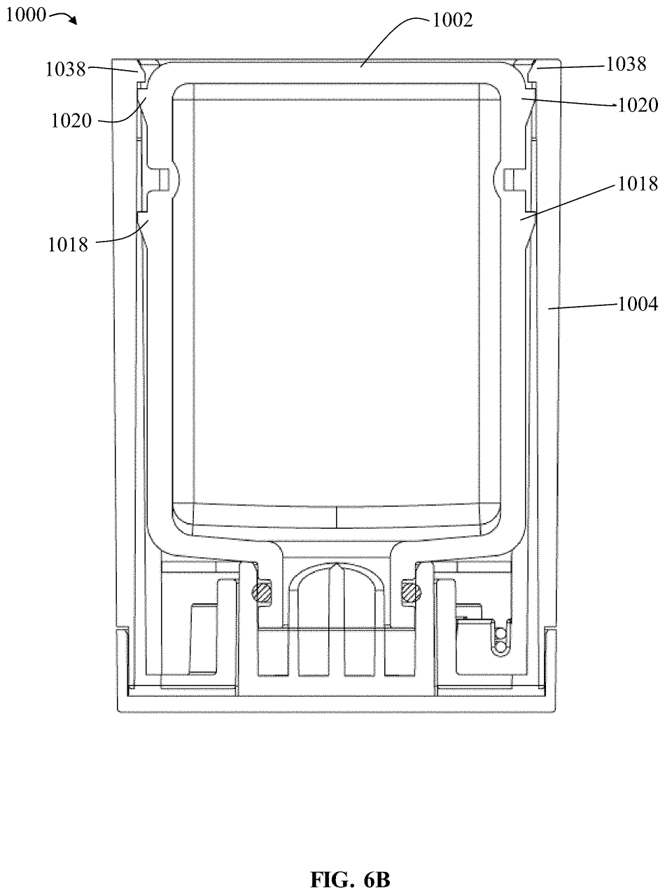

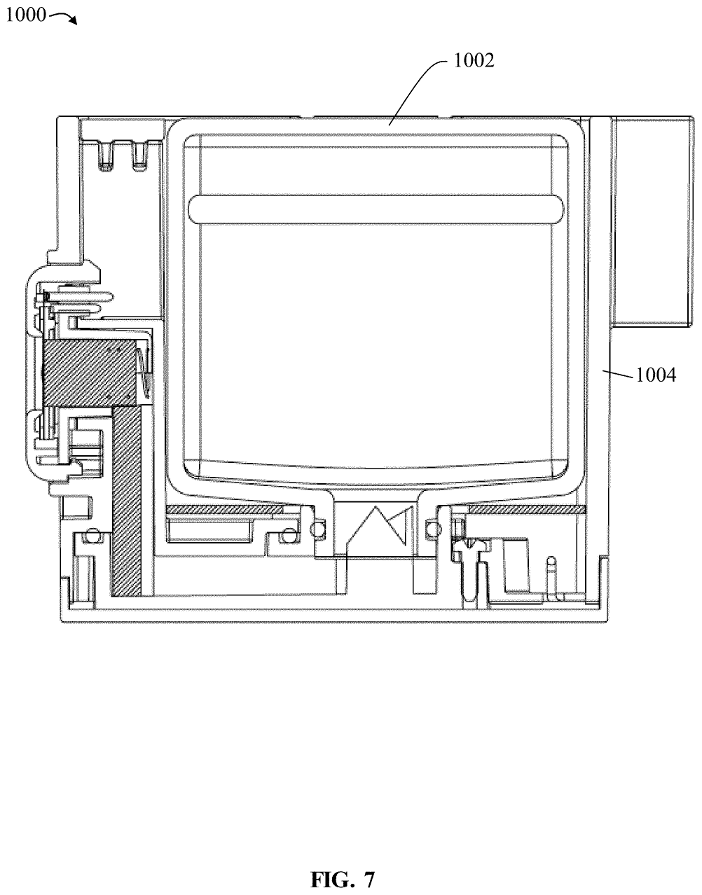

Reservoir 1002 in the embodiment depicted is movable from a first position (FIGS. 1, 5, 6A) in which reservoir 1002 is closed and fluid is prevented from flowing from the bottle, to a second position (FIGS. 3, 6B, 7) in which reservoir 1002 is open and liquid may flow from the reservoir. Reservoir 1002 may have a lower retaining member 1018 and an upper retaining member 1020 (one each shown in FIG. 4; both shown in FIGS. 6A-B). In this embodiment, retaining members 1018, 1020 are in the form of tabs or wings that extend outwardly from the sides of the reservoir 1002. Cartridge body 1004 in this embodiment has a finger 1036 on either side of the housing body, each with a respective retaining member 1038. In the embodiment shown, the retaining members 1038 are tabs or wings that extend inwardly from the inner side of the fingers 1036, and correspond to and engage with the tabs or wings 1018 and 1020 when the reservoir 1002 is inserted in the cartridge body 1004. With the reservoir in a first position (FIG. 6A), lower retaining members 1018 of reservoir 1002 may engage with retaining members 1038 of cartridge body 1004. In a second position (FIG. 6B), upper retaining members 1020 of reservoir 1002 may engage with retaining members 1038 of the cartridge body 1004.

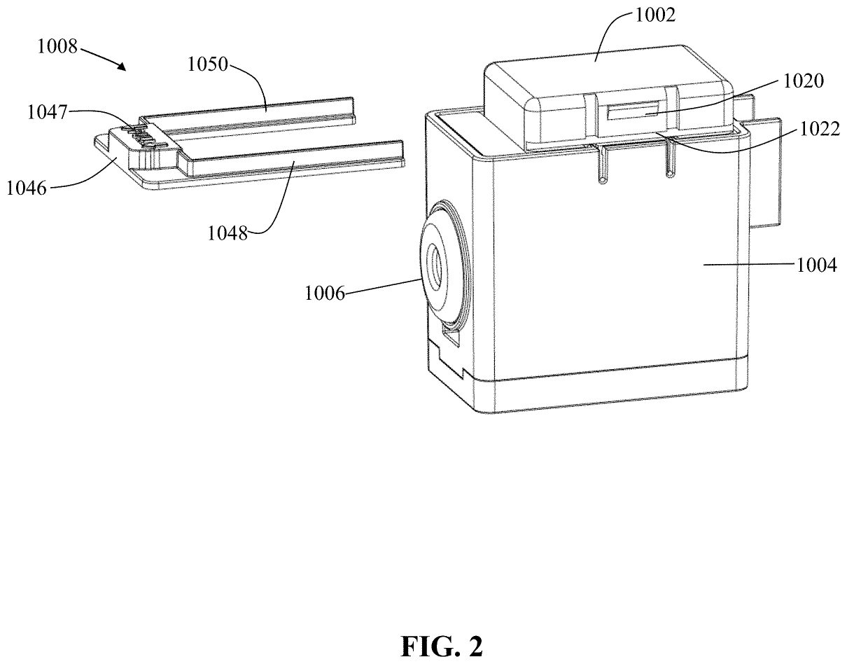

Reservoir 1002 in the embodiment depicted further has a pair of side channels 1022 (one shown in FIGS. 2 and 4; two shown in FIGS. 6A-B) that extend along the side of the reservoir 1002, one on each side, and each extending between a respective set of upper and lower retaining members 1018, 1020. In this embodiment, retainer 1008 (FIG. 1) may be installed within channels 1022 to selectively lock reservoir 1002 in a first position or prevent reservoir 1002 from moving from a first to second position, for example, unintendedly prior to use or during shipping or transportation.

With reference to FIGS. 4 and 8, a receiver 1060 may be positioned inside of the housing body 1030 and secured bottom plate 1057 (FIG. 8). In the embodiment shown, receiver 1060 is secured by screws 1053 and 1061 that extend through the bottom plate 1057 and through bosses 1077, 1078, 1079, 1080, and 1081 of receiver 1060. As mentioned, and will be recognized, other suitable ways of securing components together may be utilized, such as adhesive, welding, snap-fit, or for example, such components may be formed together as a single piece. A gasket 1056 is positioned between the bottom plate 1057 and the housing base cap 1052 and has a space for receiver 1060. Receiver 1060 in this embodiment includes a socket 1062 that is shaped to receive the neck 1012 of reservoir 1002. A knife or piercing member 1064 with an angled leading edge may be positioned within the socket 1062. In this embodiment, a piercing member 1064 is utilized and positioned to pierce cover 1015 of reservoir 1002 when reservoir is moved into a second position pressed into the cartridge body 1004. A receiver fluid channel 1066 extends from and is in fluid communication with socket 1062. Receiver 1060 further includes a seal member 1070 positioned in a seat 1068. As can be seen in FIG. 5, the seal 1070 seals against the bottom surface of bottom plate 1057 of housing body 1030.

As best seen in FIGS. 5, 7 and 11, a wick 1072 and a wick 1073 are positioned in the housing body 1030 and carry fluid from the receiver fluid channel 1066 to a piezoelectric discharge plate 1086 of nozzle 1006. Wick 1072 in the embodiment shown is a vertical wick that is vertically oriented and has a generally rectangular cross section. Many various shapes and orientations are possible. For example, wick 1072 may have other cross-sectional shapes, such as square, circular, round, or oblong. In embodiments, the cross-sectional shape and size may vary along its length. In the embodiment depicted, wick 1072 includes an air channel 1120 and is embodied as a cutout portion running the length of 1072 that allows air to flow therethrough. In embodiments, air channel 1120 provides pressure relief from the bottle by allowing air to flow back to the bottle from the nozzle as fluid from the reservoir 1002 is dispensed. Air channel 1120 in embodiments may have various shapes and cross sections, and may, for example, be a cutout, a channeled area, a cored area, or other space for air to travel through the wick. In embodiments, air channel 1120 is a cut at the top of the wick. In other embodiments, an air channel is along the side of the wick channels, bypasses the wick channels, or is made through the housing, or an opening at the reservoir and, in embodiments is not part of the wick. In certain embodiments, air channel is a 1 mm air channel. Wick 1072 also includes a seat 1121 which, in the embodiment shown, is an arc-shaped cutout at the top of wick 1072.

Wick 1073, in the embodiment shown, is a horizontal wick that is horizontally oriented. In this embodiment, wick 1073 is generally cylindrical in shape, having a generally circular cross section. Like wick 1072, wick 1073 in embodiments may have various orientations, shapes, and sizes. Wick 1073 is positioned in contact with seat 1121 to allow for liquid transfer from wick 1072 to wick 1073. In the embodiment shown, the circular cross-sectional shape of wick 1073 is complimentary to the circular arc shape of seat 1121 so that wick 1073 is in full contact with wick 1072 to assist with fluid transfer. Many various shapes and orientations are possible. For example, wick 1073 may have other cross-sectional shapes, such as square, circular, round, or oblong. In embodiments, the cross-sectional shape and size may vary along its length. In some embodiments, wick 1073 has a u-shaped cross section.

Turning to FIG. 5, wick 1072 is positioned in a wick channel 1074 of housing body 1030 that may be formed by the interior surface 1075 of the housing body 1030, and a wick channel wall 1076. Wick 1072 is positioned with a lower portion in the receiver fluid channel 1066 and an upper portion positioned in the wick channel 1074. Wick channel wall 1076, together with interior surface 1075, collectively surround wick 1072 on all sides. In the embodiment shown, wick 1072 presses against each of the surfaces 1075, 1076 along the length of the wick 1072 in the wick channel 1074 and the wick 1072 is airtight within wick channel 1074. Air external to the system may not enter (except for air that may be exchanged at the micro-perforated plate that may flow back through air channel 1120 and into the reservoir). The upper surface of wick 1072 is in contact with wick 1073, which is positioned in piezoelectric discharge nozzle 1006. Piezoelectric discharge nozzle 1006 is positioned through the opening 1032 (FIG. 4) of housing body 1030.

Wicks 1072 and 1073 in embodiments may be a single wick, plural wicks, such as two wicks, and may comprise a single material or multiple materials. In embodiments, more than two wicks are utilized, such as three, four, or more wicks. In embodiments, a single wick is used. In embodiments, a single wick has multiple components. In certain embodiments, a single wick has a first component and a second component. For example, one such embodiment has a horizontal component and a vertical component. Various of the components may be made of the same or different material, the same or different pore size, and provide for the same or different flow rates. In certain embodiments, a single wick is used with a fibrous portion and a sintered wick portion. A sintered wick, for example, in embodiments is molded from particles of a porous material, such as a plastic, fused together under pressure. In other embodiments, two wicks are used where the first wick is a first material and the second wick is a second material. In embodiments, the wick may comprise a first portion and a second portion, where the first portion is fibrous and the second portion is non fibrous. In embodiments, the first and second portions are separate wicks. In embodiments, wicks desirably provide a proper amount of liquid at the nozzle to prevent over-saturation, under-saturation, or flooding of the piezoelectric nozzle. In embodiments, wick 1072 and wick 1073 are different materials and optimize flow to the piezoelectric discharge nozzle and to properly meter fluid at the nozzle. In embodiments, wick 1072 is a sintered wick. In an embodiment, a wick may have fused particles with microscopic gaps. The microscopic gaps in embodiments may have selected pore size to ensure optimal flow to the flow head without, for example, flooding. In some embodiments the pore size of the wick is from 1-20 microns. In some embodiments the wick is a sintered wick with a pore size of 1-20 microns. In embodiments, the wick material is or contains polyethylene. In one example, the wick is a polyethylene wick having a pore size in the range of 1-20 microns that may be sintered. In embodiments, the wick material includes polypropylene. In embodiments, wick 1073 is a fibrous wick, such as a felt wick, that delivers liquid to the micro-vibratory plate in the piezoelectric discharge nozzle without flooding and without undersupplying the plate. In some embodiments, a fibrous wick comprises cotton. In embodiments, a fibrous wick desirably compresses evenly against the piezoelectric plate and may provide an even distribution of liquid to the plate. In embodiments, a wick such as wick 1073 is compressed by a spring to bias the wick against the piezoelectric plate. In embodiments, a wick such as wick 1073 is shaped to be compressed in its wick channel so that the wick is pressed against a piezoelectric plate.

In embodiments, the wicks desirably optimize assembly and strength. For example, due to the fact that a sintered material in embodiments is relatively rigid compared to, for example, a fabric wick, it may be pressed into the vertical wick channel under mechanical pressure without risk of deformity. Wicks having less rigidity may take further time and expense to assemble, for example. In embodiments, the sintered wick enables for a precise fit into the wick channel and reduces or eliminates areas where air or liquid may travel around the wick. Additionally, in embodiments with a horizontal wick positioned on a vertical wick, the vertical wick may provide structural support for the horizontal wick. In such embodiments, a sintered vertical wick may provide structural support compared to other wick materials, including many fibrous wicks. In embodiments, by using a relatively rigid vertical sintered wick, efficient assembly or manufacture may be achieved, for example, due to the ability of the sintered wick to be placed in the same position for each assembly and within tolerance. In embodiments, with the vertical sintered wick accurately placed for each assembly, a horizontal wick may also be accurately placed as it is positioned on the vertical wick. In such a configuration, consistent wick-to-wick contact may also be achieved.

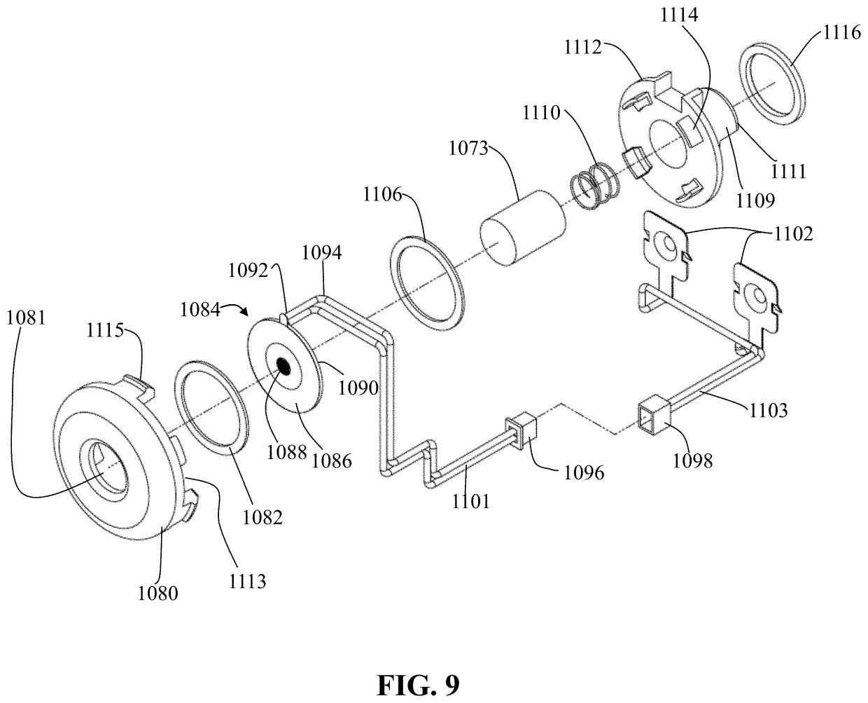

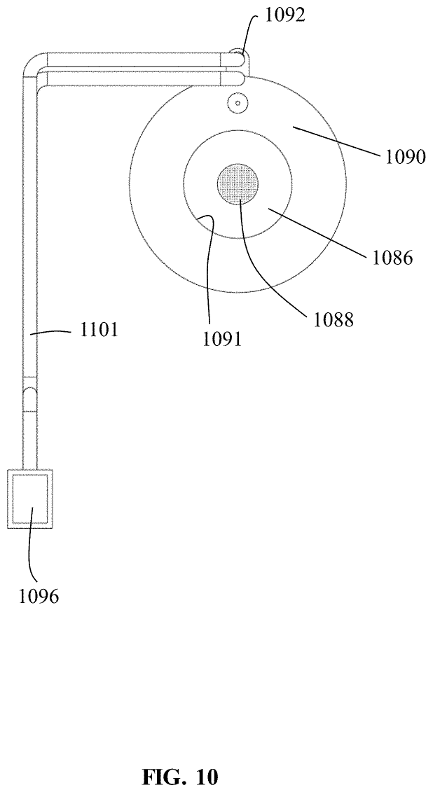

With reference to FIG. 9, piezoelectric discharge nozzle 1006 includes micro-perforated vibratory plate 1086 which, in the embodiment shown is a stainless steel plate, having micro-perforations 1088 through which liquid is discharged. Turning to FIG. 10, on an inside surface of the micro-perforated vibratory plate 1086 is a piezoelectric element 1090. In the embodiment shown, the piezoelectric element 1090 is a donut-shaped piezoelectric vibrator that surrounds the micro-perforations 1088.

Fluid is atomized and exits piezoelectric discharge nozzle 1006 through micro-perforations 1088 of the micro-perforated vibratory plate 1086. In some embodiments, micro-perforations 1088 are uniform in size. In embodiments, the micro-perforations may have a size selected from the range 5 uM to 11 uM (diameter). In other embodiments, other sizes outside of that range are used. In many embodiments, micro-perforations vary in size. Such variously sized micro-perforations in embodiments are selected from a range of 5 uM to 11 uM. Smaller perforations may result in a lighter mist that remains in the air longer and may spray farther than larger perforations. Larger perforations may result in larger, heavier particles with a shorter range. By mixing various sized perforations on the same plate, for example, the dispenser emits some lighter particles that may travel further with air currents, and other heavier or larger particles that have a shorter range. The perforation size may be selected to achieve the desired particle size, spray distance, or time that particles are airborne, among other characteristics. Perforation size may be selected to achieve a desired volume and flow rate, which in turn affects the amount of time that may be required for dispensation. Many various patterns of micro-perforation arrays may also be used to achieve desired spray characteristics. Perforation size or pattern in embodiments may be selected to ensure that liquid dispensed does not contact the dispenser, or a nozzle end cover, for example, and thus reduces or eliminates blow-back that may build-up and lead to undesirable dripping from the nozzle. In addition, various spray patterns may be achieved by selecting the micro-perforation size and pattern. Many spray patterns that vary visually, such as a conically-shaped spray pattern, have varying degrees of performance are achievable.

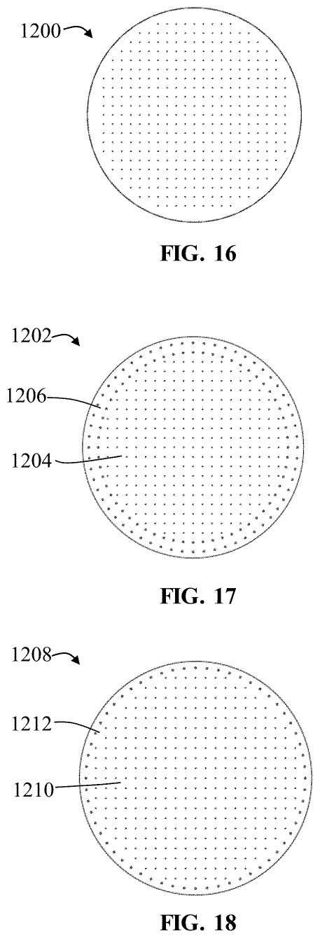

For example, in an embodiment shown in FIG. 16, micro-perforations 1200 are shown in a grid pattern, and the perforation size is constant. In another embodiment shown in FIG. 17, micro-perforations 1202 include a set of micro-perforations 1204 in a grid pattern and of a first size, and a set of micro-perforations 1206 as multiple rows of micro-perforations distributed radially about the perimeter of the array. Micro-perforations 1206 in the embodiment shown have a larger size than the micro-perforations 1204. In yet another embodiment shown in FIG. 18, micro-perforations 1208 include a set of micro-perforations 1210 in a grid pattern and of a first size, and a set of micro-perforations 1212 as a single row of micro-perforations distributed radially about the perimeter of the array. Micro-perforations 1212 in the embodiment shown have a larger size than the micro-perforations 1210. In various embodiments, at least some micro-perforations of a larger size are located radially further from the center of the perforation pattern than smaller-size micro-perforations. In other embodiments, the smaller micro-perforations are located further from the center. In yet others, variously sized perforations are used along the perimeter or near the center to achieve desired spray patterns.

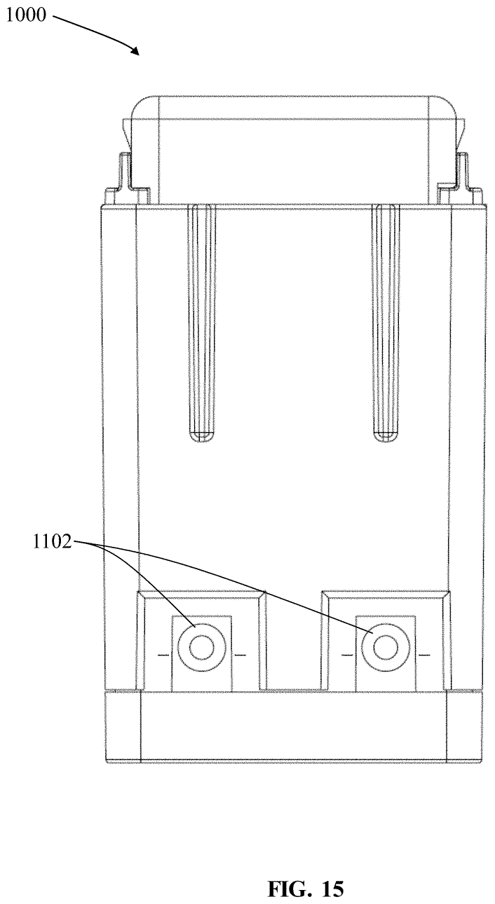

Returning to FIG. 9, electrical connections 1092, such as soldering, connect a wiring harness 1101 with an end connector 1096, which is connectable to end connector 1098 of a wiring harness 1103 with electrical contacts 1102 (also seen in FIG. 15), which connect to contacts of a dispenser unit when the cartridge is installed in a dispenser. When installed in a dispenser, then, a power source and control unit in the dispenser can control the piezoelectric element 1090 to vibrate the micro-vibratory plate 1086 to atomize and dispense liquid from the nozzle 1006.

With reference to FIGS. 5 and 9, the vibratory plate 1086 and piezoelectric element 1090 are connected to cartridge body 1004 by a nozzle end cover 1080. Nozzle end cover 1080 has a discharge opening 1081 coincident with the opening 1032 (FIG. 4) and the micro-perforated vibratory plate 1086. Clip members 1115 of the nozzle end cover 1080 cooperate with openings 1117 in the cartridge body 1004 to secure the nozzle end cover 1080 to the cartridge body and hold the micro-perforated vibratory plate 1086 in place. A nozzle back plate 1112 includes clip members 1114 that cooperate with corresponding retention members 1113 of the nozzle end cover 1080 to secure the nozzle back plate 1112 to the nozzle end cover 1080. A nozzle washer 1082 is positioned between the inside of nozzle end cover 1080 and micro-perforated vibratory plate 1086 and a nozzle washer 1106 is positioned between the micro-perforated vibratory plate 1086 and the nozzle back plate 1112. The nozzle washers 1082, 1106 seal against their respective contact surfaces and prevent fluid from escaping radially outward. In an embodiment, the nozzle washers are felt washers. In other embodiments, the nozzle washers are rubber gaskets. Any suitable gasket may be used.

Wick 1073 is positioned in piezoelectric discharge nozzle 1006 in a wick channel 1118. In the embodiment shown, wick channel 1118 is formed by the inner surface of nozzle back plate 1112, including an extension section 1109 of nozzle back plate 1112, the inner surface 1091 (FIG. 10) of piezoelectric element 1190, the plate 1086, and an upper surface of wick 1073, as can be seen in FIG. 5. Wick 1073 engages the micro-perforated vibratory plate 1086 so that liquid flows to micro-perforations 1088. In the embodiment shown, an elastic member 1110, such as a spring, is positioned against an end wall 1111 of the nozzle back plate 1112 and presses against wick 1073 against vibratory plate 1086. In other embodiments, an elastic member is omitted and wick 1073 at one end is in contact with the end wall 1111 and compressed within the wick channel 1118 so that it its other end is held in contact with micro-vibratory plate 1086. In the embodiment shown, wick 1073 presses against each of the surfaces of wick channel 1118 and wick 1073.

In embodiments, the nozzle height with respect to the height of liquid in the reservoir (as well as other factors, such as wick configuration and material) may be selected to ensure proper metering of fluid to the nozzle. Proper metering provides, for example, sufficient liquid to the nozzle without oversaturating and flooding the nozzle. With the height of fluid in the reservoir higher than the nozzle, the system has head pressure that causes fluid to flow from the reservoir towards the nozzle, including up the vertical wick, as fluid overcomes resistance along the fluid flow path and wick effect. In embodiments, the height of the nozzle may be selected to match the resistance provided along the fluid flow path from the reservoir to the nozzle, including resistance from the wick, so that, when the reservoir is full and first opened, the system charges and a sufficient volume of fluid is provided to the nozzle so that the device may operate without flooding. In some such embodiments, after the system charges, the height of the fluid is at or near the level of the nozzle and there is little or no head pressure. In embodiments, the height of the bottle is lower or higher to adjust the head pressure. In embodiments, the nozzle height is approximately midway with respect to the liquid fill level of a full reservoir. In embodiments, the nozzle height is approximately in the middle third of the height of the liquid fill level of a full reservoir. In embodiments the nozzle is moved lower which, in embodiments, may reduce dripping of liquid on the dispenser or cartridge. For example, in embodiments the nozzle height is in the bottom third or quarter of the height of the liquid fill level of a full reservoir, or at or near the bottom of the cartridge.

Referring again to FIGS. 1 and 2, retainer 1008 in the embodiment shown is in the form of a removable pull-tab retainer. When installed (FIG. 1), retainer 1008 locks reservoir 1002 in a first position, or restricts reservoir 1002 from moving to a second position, so that fluid may not flow from reservoir 1002. When removed (FIG. 2), reservoir 1002 may be moved to a second position (FIG. 3) to allow fluid flow from the reservoir. Many different retainer features may be utilized, and in the embodiment shown, retainer 1008 is in the form of a removable pull-tab retainer. In the embodiment depicted, retainer 1008 includes a grab handle or member 1046 and a pair of legs 1048, 1050. Each leg 1048, 1050 corresponds to a respective side channel 1022 of reservoir 1002.

When the retainer 1008 is installed (FIGS. 1, 6A), each leg 1048, 1050 is positioned within a respective side channel 1022 of the reservoir 1002. When installed, reservoir 1002 is locked in place and cannot be fully removed or pressed further into the interior space 1016 (FIG. 4) of the cartridge housing body, for example, into a second position where fluid flow is enabled, due to abutment of retainer 1008 with the housing body 1030 in the channels 1022. Retainer 1008 of the type depicted may be removed by grasping the retainer and pulling outwardly so that legs 1048, 1050 slide out from respective side channels 1022 and disengage reservoir 1002. In the embodiment shown, grab handle or member 1046 may provide a surface for a user to grasp to facilitate removal of the retainer, and a user may use any surface of the retainer 1008 to move the legs out of the channel.

Retainer 1008 in the embodiment shown further includes indicia 1047, which informs a user how to disengage the retainer 1008. In the embodiment shown, indicia 1047 includes text that reads “PULL” and graphics in the form of arrows that point in the direction the retainer should be moved to disengage from the cartridge. Other indicia may be used to communicate useful functions, such as operational instructions, to the user. For example, various text and characters, numbers, colors, graphics, such as pictures demonstrating operation, arrows, and gestures, among other indicia, are possible to inform a user about operation of the cartridge. Other locations on the cartridge may be used for indicia. For example, indicia may be placed on the reservoir, nozzle, dispenser, cartridge body 1004, or another location on the retainer. Indicia may, in embodiments, inform a user on placing the reservoir in various positions, dispenser installation, or other functions.

Many other embodiments are possible for a retainer. For example, in embodiments the retainer includes a tab that is connected to cartridge that prevents the reservoir from being moved to a second position. In an embodiment, a perforated pull tab is attached to the cartridge that may be pulled to be removed and, as it is removed, breaks along perforations. A tab may be inserted in a channel, opening, cutout, or another portion of the cartridge. Another tab may also have a weakened or thinned area that breaks away to break the tab from the device. In still other embodiments, a wrapping, such as a shrink wrap, may be used. In another embodiment, tape that prevents the reservoir from being moved to a second position until removed. In yet other embodiments, the retainer is or contains an adhesive that may be removed or broken through. In embodiments, retainer includes a threaded screw cap. Many various retainer features may be utilized to keep reservoir secure.

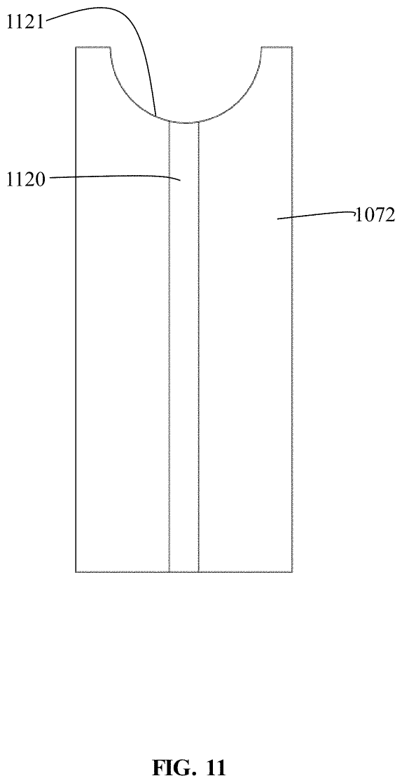

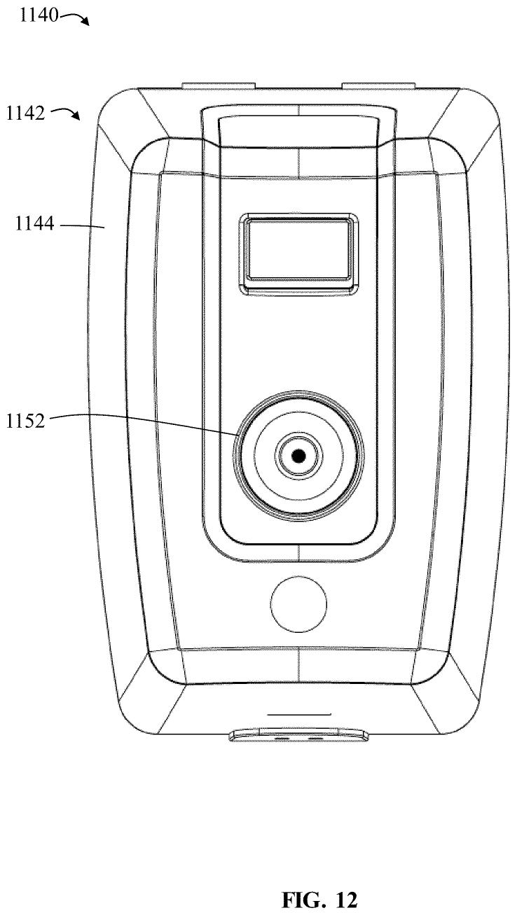

Piezoelectric dispenser cartridge 1000 may be installable in a dispenser that provides circuitry and power to drive the piezoelectric discharge nozzle 1006. Referring to FIGS. 12-14, dispenser 1140 includes a housing 1142 with a backing plate 1143 and hinged cover 1144 attached to backing plate 1143 with a hinge 1148. Cartridge 1000 in the embodiment shown is received by the dispenser 1140 by a retention seat 1141. In other embodiments, cartridge 1000 may be installed in, secured to, or attached to the dispenser in various ways, for example, placed in an opening in the dispenser, a shelf, a snap-fit retainer or mechanism, adhesive, among many others as will be recognized.

Dispenser 1140 further includes a power source compartment 1145 with a power source 1146, such as a battery or batteries, or a battery pack, other DC power source, or an A/C power source, such as a source that plugs into a 120-240 v AC outlet, which is electrically connected to electrical contacts 1147 that correspond to electrical contacts 1102 of cartridge 1000 when cartridge 1000 is installed in dispenser 1140. In the embodiment shown, power source 1146 is a battery. A spring-loaded release button 1150 at the bottom rear of the front cover 1144 can be depressed in order to release the cover 1144 to access the inside of the dispenser 1140 where cartridge 1000 is installable. The cover has an aperture 1152 through which atomized liquid from the cartridge 1000 is released during operation. Dispenser 1140 may further include a control unit 1154 connected to battery source 1145 and contacts 1147. In embodiments, the control unit may include a processor, a control board or controller, timer, or other circuitry to control the piezoelectric element 1090 to vibrate plate 1086 selectively to cause cartridge 1000 to dispense liquid from piezoelectric nozzle 1006. For example, the time, duration, frequency, periodicity, or other variables may be controlled to achieve desirable dispensation. In some embodiments, a control unit is a timer unit. In some embodiments, control unit includes a piezoelectric driver circuit. For example, certain piezo driver circuits may be employed as disclosed by U.S. Pat. Pub. No. 2018/0043048, filed on Jul. 27, 2017, which is hereby incorporated by reference in its entirety.

In operation, cartridge 1000 can be activated and installed into a dispenser such as dispenser 1140 to enable cartridge 1000 to dispense atomized liquid. With reference to FIGS. 1, 5, and 6A, reservoir 1002 is in a first position and reservoir is closed by seal 1015. Retainer 1008 prevents reservoir 1002 from being pressed down into a second position by abutment of legs 1048, 1050 with the upper surface of housing body 1030 and the channel 1022. The engagement of lower retaining members 1018 with retaining members 1038 prevent reservoir 1002 from being removed from cartridge body 1004 in the embodiment shown.

Retainer 1008 may be removed (FIG. 2). With reference to FIGS. 5, 6B and 7, reservoir 1002 may then be pressed down to a second position, where, in the embodiment shown, upper retaining members 1020 engage with retaining members 1038 to secure reservoir 1002 in a second position. As reservoir 1002 is pressed into a second position, piercing member 1064 pierces through cover 1015 to place reservoir 1002 in an open state where fluid my exit. With reservoir 1002 fully inserted into the cartridge body 1004 in a second position, neck 1012 of reservoir 1002 is seated in socket 1062 of receiver 1060. O-ring 1014 seals the perimeter of the neck 1012 to the inner surface of socket 1062 to prevent leaking of fluid therein. With cover 1015 open, fluid from reservoir 1002 may flow from the reservoir and into the receiver fluid channel 1066. A fluid flow path forms from the reservoir 1002, through socket 1062 and fluid channel 1066, into wick 1072 and wick 1073 and to micro-vibratory plate 1086 with perforations 1088. Such fluid flow path from, for example, a tight fitment of the wick 1073 and from seals (such as seals 1070 and 1014) along the flow path, yield a sealed, airtight flow path from the reservoir to the top of vertical wick 1072 (except for air that may be exchanged at the micro-perforated plate that may flow back through air channel 1120 and into the reservoir).

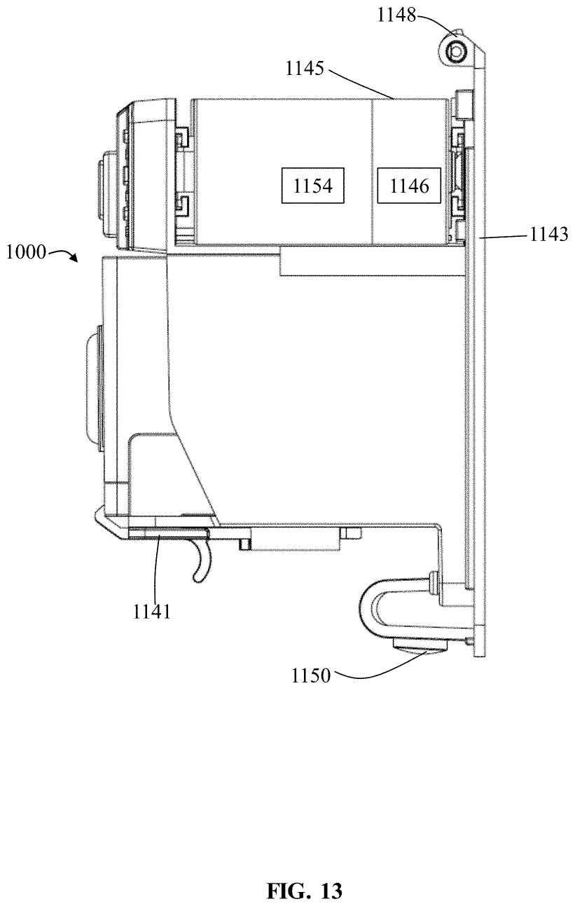

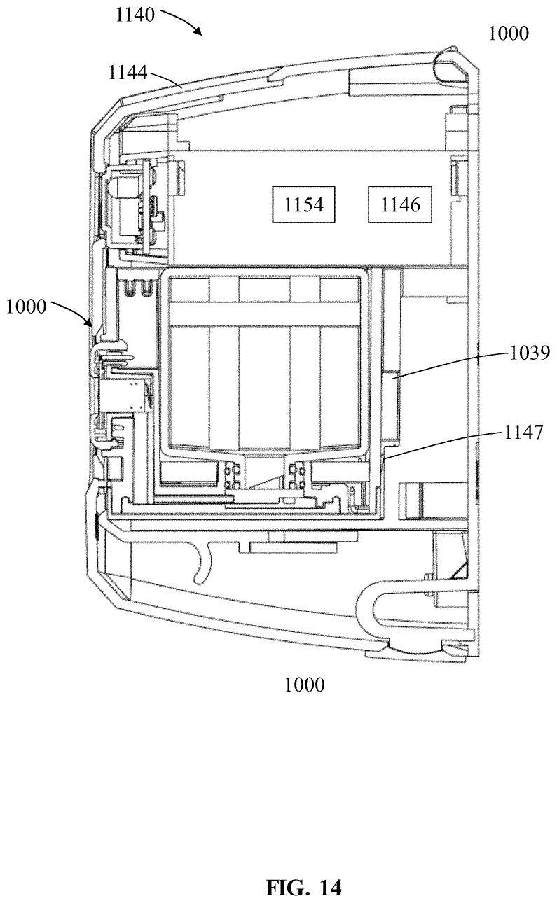

Cartridge 1000 may be installed into a dispenser, such as dispenser 1140. Cartridge 1000, in the embodiment shown, is snapped into place as depicted in FIGS. 13-14. With the cartridge 1000 installed in dispenser 1140, electrical contacts 1102 engage with corresponding electrical contacts 1147 of the dispenser (FIG. 14). Cartridge may then be controlled by, for example, controller 1154 of dispenser 1140 to selectively activate piezoelectric element 1084 to vibrate, causing micro-perforated plate 1086 to vibrate in contact with or adjacent to wick 1073. Liquid in wick 1073 is atomized and dispensed through the perforations 1088 as is desired. After all the liquid from reservoir 1002 is depleted, cartridge 1000 may be removed from dispenser 1140 and recycled or otherwise disposed of, and replaced with a new cartridge 1000 that is full of fluid. Reservoir 1002 may also be refilled, or, an empty reservoir 1002 may be replaced with a new reservoir 1002 that has liquid to dispense.

Cartridges of the type disclosed herein may dispense many various liquids desired. In some embodiments, the cartridge is an air-freshener cartridge that dispenses liquid air freshener. In others, the cartridge includes other liquids, such as water, fragrance, insect repellent, sanitizer, or mal-odor counteractant, among others.

Many various embodiments are possible in addition to those expressly described, as will be recognized. For example, in embodiments, the reservoir may be part of the cartridge body or otherwise not separate from the cartridge body. In others, the reservoir is part of the exterior of the liquid cartridge, and not installable within the dispenser. While in embodiments the power source and driver circuitry are part of the dispenser, in other embodiments, one or more of the power source and control unit is part of the cartridge.

In some embodiments, a reservoir is not movable and is within the cartridge body. In embodiments, the cartridge body includes an outer housing. In some embodiments, the cartridge body does not include housing. In embodiments, the cartridge body and the reservoir. The reservoir in embodiments may be various sizes and shapes and have various orientations.

The above-cited patents and patent publications are hereby incorporated by reference in their entirety. Where a definition or the usage of a term in a reference that is incorporated by reference herein is inconsistent or contrary to the definition or understanding of that term as provided herein, the meaning of the term provided herein governs and the definition of that term in the reference does not necessarily apply. Although various embodiments have been described with reference to a particular arrangement of parts, features, and the like, these are not intended to exhaust all possible arrangements or features, and indeed many other embodiments, modifications, and variations will be ascertainable to those of skill in the art. Thus, it is to be understood that the teachings of the subject disclosure may therefore be practiced otherwise than as specifically described above.

1. A piezoelectric liquid cartridge for a dispenser unit, the dispenser unit including a housing with a power source, a control unit, and electrical contacts, the piezoelectric liquid cartridge comprising:
a cartridge body;
a piezoelectric discharge nozzle supported by the body and including a micro-perforated vibratory plate;
a liquid reservoir supported by the body;
a wick;
a liquid path from the liquid reservoir to the piezoelectric nozzle, the liquid path including a channel, the wick at least partially positioned in the channel, the wick including a first fibrous wick portion in engagement with the vibratory plate of the piezoelectric discharge nozzle and a second non-fibrous wick portion; and
electrical contacts connected to the micro-perforated vibratory plate, wherein the piezoelectric cartridge is installable in the housing of the dispenser unit with the electrical contacts of the cartridge connected to corresponding electrical contacts of the dispenser to enable the micro-perforated vibratory plate to release atomized liquid particles from the piezoelectric discharge nozzle.

2. The piezoelectric liquid cartridge of claim 1, wherein the second wick portion comprises microscopic pores.

3. The piezoelectric liquid cartridge of claim 2, wherein the microscopic pores have a diameter of 1-20 microns.

4. The piezoelectric liquid cartridge of claim 1, further comprising an elastic member positioned to bias the first wick portion against the micro-perforated vibratory plate.

5. The piezoelectric liquid cartridge of claim 1, wherein the first and second wick portions comprise first and second wicks, and the first wick is positioned in contact with the second wick to enable transfer of fluid from the second wick to the first wick.

6. The piezoelectric liquid cartridge of claim 1, wherein the second wick portion is a sintered wick portion.

7. The piezoelectric liquid cartridge of claim 1, wherein the liquid reservoir is movable from a first position in which the liquid reservoir is sealed to a second position in which the liquid reservoir is unsealed, the piezoelectric liquid cartridge further comprising a first retaining member configured to secure the liquid reservoir in a first position.

8. The piezoelectric liquid cartridge of claim 7, further comprising a second retaining member configured to secure the liquid reservoir in a second position.

9. The piezoelectric liquid cartridge of claim 1, wherein:
the liquid reservoir is movable from a first position in which the liquid reservoir is sealed to a second position in which the liquid reservoir is unsealed, the piezoelectric liquid cartridge further comprising a removable retainer configure to prevent the liquid reservoir from being moved to the second position.

10. The piezoelectric liquid cartridge of claim 9, wherein the removable retainer includes at least one leg that engages a channel of the fluid reservoir to prevent the liquid reservoir from being moved to the second position.

11. The piezoelectric liquid cartridge of claim 1, wherein the micro-perforated vibratory plate includes a micro-perforation array having micro-perforations with a first size and a second size.

12. The piezoelectric liquid cartridge of claim 11, wherein the micro-perforations of the first size are positioned around the outer portion of the micro-perforation array.

13. A piezoelectric liquid cartridge for a dispenser unit, comprising:
a cartridge body;
a piezoelectric discharge nozzle supported by the body and including a micro-perforated vibratory plate;
a liquid reservoir supported by the body; and
a wick at least partially defining a liquid flow path from the liquid reservoir to the piezoelectric nozzle, the wick including a first fibrous wick portion in engagement with the vibratory plate of the piezoelectric discharge nozzle and a second non-fibrous wick portion.

14. The piezoelectric liquid cartridge of claim 13, wherein the second wick portion comprises microscopic pores.

15. The piezoelectric liquid cartridge of claim 13, further comprising an elastic member positioned to bias the first wick portion against the micro-perforated vibratory plate.

16. The piezoelectric liquid cartridge of claim 13, wherein the first and second wick portions comprise first and second wicks, and the first wick is positioned in contact with the second wick to enable transfer of fluid from the second wick to the first wick.

17. The piezoelectric liquid cartridge of claim 13, wherein the second wick portion is a sintered wick portion.

18. The piezoelectric liquid cartridge of claim 13, wherein the liquid reservoir is movable from a first position in which the liquid reservoir is sealed to a second position in which the liquid reservoir is unsealed, the piezoelectric liquid cartridge further comprising a first retaining member configured to secure the liquid reservoir in a first position.

19. The piezoelectric liquid cartridge of claim 18, further comprising a second retaining member configured to secure the liquid reservoir in a second position.

20. A piezoelectric liquid cartridge for a dispenser unit, the dispenser unit including a housing with a power source, a control unit, and electrical contacts, the piezoelectric liquid cartridge comprising:
a cartridge body;
a piezoelectric discharge nozzle supported by the body and including a micro-perforated vibratory plate with micro-perforations having a first size and a second size;
a liquid reservoir supported by the body;
a wick;
a liquid path from the liquid reservoir to the piezoelectric nozzle, the liquid path including a channel, the wick at least partially positioned in the channel, the wick including a first fibrous wick portion in engagement with the vibratory plate of the piezoelectric discharge nozzle; and
electrical contacts connected to the micro-perforated vibratory plate, wherein the piezoelectric cartridge is installable in the housing of the dispenser unit with the electrical contacts of the cartridge connected to corresponding electrical contacts of the dispenser to enable the micro-perforated vibratory plate to release atomized liquid particles from the piezoelectric discharge nozzle.
